(19) United States
(12) Patent Application Publication
(10) Pub. No.: US 2007/0199920 A1
(43) Pub. Date: Aug. 30, 2007

(54) CONCAVE/CONVEX PATTERN FORMING METHOD AND INFORMATION RECORDING MEDIUM MANUFACTURING METHOD

(75) Inventors: Minoru Fujita, Toyko (JP); Mitsuru Takai, Tokyo (JP); Akimasa Kaizu, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/677,321

(22) Filed: Feb. 21, 2007

(30) Foreign Application Priority Data
Feb. 28, 2006 (JP) 2006-052242
Nov. 17, 2006 (JP) 2006-311360

(51) Int. Cl. B44C 1/22

(52) U.S. Cl. 216/52

(57) ABSTRACT

A concave/convex pattern forming method which makes it possible to easily press a stamper against a resin layer, and sufficiently maintain the shape of the concave/convex pattern after removing the stamper. During a resin layer forming process, the resin layer is formed using a resin material having a glass transition temperature higher than room temperature. During a pressing process, temperature control is performed such that temperatures of a substrate, the resin layer, and the stamper become higher than the glass transition temperature of the resin material by not less than 5° C. During a removing process, temperature control is performed such that temperatures of the substrate, the resin layer, and the stamper become not higher than a temperature 20° C. higher than the glass transition temperature of the resin material, and are equal or approximately equal to the temperatures of the substrate, the resin layer, and the stamper during the pressing process.

### BACKGROUND OF THE INVENTION

1. Field of the Invention

The present invention relates to a method of forming a concave/convex pattern by pressing a stamper against a resin layer formed over a substrate, and a method of manufacturing an information recording medium by using the concave/convex pattern formed by the concave/convex pattern forming method.

2. Description of the Related Art

As a concave/convex pattern forming method of this kind, the present assignee has proposed a concave/convex pattern forming method in Japanese Laid-Open Patent Publication (Kokai) No. 2005-339669, which forms a concave/convex pattern on a resin layer of an intermediate (substrate) for manufacturing an information recording medium by an imprinting method. In this concave/convex pattern forming method, first, a resin layer is formed on the intermediate by coating the intermediate with a novolak resin (hereinafter referred to as “the resin material”) having a glass transition temperature of 70° C. Then, in a state in which the intermediate formed with the resin layer and a stamper are set in a pressing machine, the intermediate (resin layer) and the stamper are heated to a predetermined temperature (170° C. in the present example) higher than the glass transition temperature of the resin material by a degree (e.g., 100° C.) within a range of not less than 70° C. to not more than 120° C. Subsequently, the concave/convex pattern of the stamper is pressed against the resin layer of the intermediate. In doing this, the convex portions of the concave/convex pattern of the stamper are smoothly pushed into the resin layer, since the resin layer is heated to a temperature higher than the glass transition temperature.

Then, the stamper is removed from the intermediate (resin layer). In doing this, when the temperatures of the intermediate and the stamper are largely changed from the start of pressing of a stamper until the completion of removal of the stamper, the intermediate (the substrate and the resin layer) and the stamper are thermally deformed (contracted or expanded). In this case, since the intermediate and the stamper are different in the thermal expansion coefficient, there occurs a difference in the amount of thermal deformation between the intermediate and the stamper, which causes deformation and displacement of the concave/convex pattern transferred to the resin layer. Therefore, in the concave/convex pattern forming method proposed by the present assignee, heat treatment is continued such that the temperatures of the intermediate and the stamper are not largely changed from the start of pressing of the stamper until the completion of removal of the same (e.g., such that the respective amounts of changes in the temperatures thereof from the start of pressing of the stamper are within a range of ±0.2° C.), and in this state, the stamper is removed from the resin layer. This causes the concave/convex pattern of the stamper to be transferred to the resin layer of the intermediate, thereby completing the process for forming the concave/convex pattern.

From the study of the proposed concave/convex pattern forming method, the present inventors found the following points for improvement. In the concave/convex pattern forming method, in order to smoothly push the convex portions of the stamper into the resin layer, the intermediate (resin layer) and the stamper are heated to a predetermined temperature higher than the glass transition temperature of the resin material forming the resin layer by a degree within a range of not less than 70° C. to not more than 120° C. Further, in the concave/convex pattern forming method, to prevent displacement of the concave/convex pattern transferred to the resin layer caused by the difference in the thermal expansion coefficients of the intermediate and the stamper, heat treatment is continuously carried out such that the respective temperatures of the intermediate and the stamper are not largely changed from the start of pressing of the stamper until the completion of removal of the same. Accordingly, in the concave/convex pattern forming method, when the removal of the stamper is completed, the temperature of the resin layer having the concave/convex pattern transferred thereto is much higher than the glass transition temperature of the resin material (by a degree within the range of not more than 70° C. to not less than 120° C.). As a result, in the disclosed concave/convex pattern forming method, there is a risk that a state can occur in which the concave/convex pattern transferred to the resin layer becomes liable to be deformed (a state in which it is difficult to maintain the shape of the concave/convex pattern) after completion of removal of the stamper, which can make it difficult to use the formed concave/convex pattern as a mask pattern, for example. Further, when an information recording medium is manufactured using the concave/convex pattern formed by the concave/convex pattern forming method e.g., as a mask pattern, there is a risk that it is difficult to form the concave/convex pattern over the whole area of the information recording medium with high accuracy.

Further, in the concave/convex pattern forming method proposed by the present assignee, the resin layer is formed on the intermediate e.g., by using a resin material having a glass transition temperature of 70° C., and during pressing of the stamper, the intermediate (resin layer) and the stamper are heated to 170° C., which is 100° C. higher than the glass transition temperature of the resin material. In this case, the temperature of the resin layer before the start of pressing of the stamper is approximately equal to room temperature, and hence to raise the temperatures of the intermediate (resin layer) and the stamper to 170° C. during pressing of the stamper, it takes a large amount of energy and long heating time. Therefore, the proposed concave/convex pattern forming method poses issues that costs required for forming the concave/convex pattern are sharply increased and throughput is decreased. Further, when an information recording medium is manufactured using the concave/convex pattern formed by the concave/convex pattern forming method, there is a risk that manufacturing costs of the information recording medium are sharply increased.

### SUMMARY OF THE INVENTION

The present invention was made in view of these issues, and a main object of the present invention is to provide a concave/convex pattern forming method which makes it possible to press a stamper against a resin layer with ease, and at the same time sufficiently maintain the shape of the concave/convex pattern after removal of the stamper, and an information recording medium manufacturing method which is capable of forming a concave/convex pattern over the whole area of an information recording medium with high accuracy. Another object of the present invention is to provide a concave/convex pattern forming method and an information recording medium manufacturing method, which are capable of decreasing costs and increasing throughput.

To attain the above object, a concave/convex pattern forming method according to the present invention comprises a resin layer forming process for forming a resin layer over a substrate, a pressing process for pressing a stamper having a stamper-side concave/convex pattern formed thereon against the resin layer, and a removing process for removing the stamper from the resin layer, thereby forming a concave/convex pattern over the substrate, wherein: during the resin layer forming process, the resin layer is formed using a resin material having a glass transition temperature higher than room temperature; during the pressing process, temperature control is performed such that respective temperatures of the substrate, the resin layer, and the stamper become higher than the glass transition temperature of the resin material by not less than 5° C.; and during the removing process, temperature control is performed such that respective temperatures of the substrate, the resin layer, and the stamper become not higher than a temperature 20° C. higher than the glass transition temperature of the resin material, and are equal or approximately equal to the respective temperatures of the substrate, the resin layer, and the stamper during the pressing process. It should be noted that throughout the present specification, the term “room temperature” is intended to mean ambient temperature around the substrate and the stamper in a work place where operations for forming the concave/convex pattern are carried out, which the respective temperatures of the substrate and the stamper gradually approach when the substrate and the stamper are left standing for a sufficiently long time without being heated or cooled. Further, when a mixed resin material which is prepared by mixing two or more kinds of resin materials is used for forming the resin layer, the respective temperatures of the substrate, the resin layer, and the stamper in each process are defined with reference to the glass transition temperature of a resin material which is a main component of the mixed resin material.

According to the concave/convex pattern forming method of the present invention, the resin layer is formed using a resin material having a glass transition temperature higher than room temperature, temperature control is performed in the pressing process such that the respective temperatures of the substrate, the resin layer, and the stamper become higher than the glass transition temperature of the resin material by not less than 5° C., and temperature control is performed in the removing process such that respective temperatures of the substrate, the resin layer, and the stamper become not higher than a temperature 20° C. higher than the glass transition temperature of the resin material, and are equal or approximately equal to the respective temperatures of the substrate, the resin layer, and the stamper during the pressing process. Since the temperature of the resin layer is controlled to be higher than the glass transition temperature of a resin material by not less than 5° C. during the process for pressing the stamper, it is possible to push the convex portions of the stamper-side concave/convex pattern smoothly deep enough into the resin layer. Further, since the temperature of the resin layer is controlled to be not higher than the temperature 20° C. higher than the glass transition temperature of the resin material, it is possible to prevent the concave/convex pattern transferred to the resin layer from being largely deformed after removal of the stamper to thereby maintain the concave/convex shape of the concave/convex pattern with high accuracy. Furthermore, since the temperature of the resin layer during the pressing process is controlled to be equal or approximately equal to the temperature thereof during the removing process, it is possible to avoid occurrence of thermal deformation of the substrate (resin layer) and the stamper to thereby prevent occurrence of displacement of the concave/convex pattern transferred to the resin layer.

Further, according to the concave/convex pattern forming method of the present invention, a resin material having a glass transition temperature of not higher than 40° C. can be used as the resin material. This makes it possible to sufficiently reduce energy required for heating the resin layer, etc. prior to the start of the pressing process, and energy required for holding the temperature e.g., of the resin layer from the start of the pressing process until the completion of the removing process, and sufficiently shorten time taken to heat the resin layer to thereby sufficiently increase throughput in forming the concave/convex pattern.

Further, an information recording medium manufacturing method according to the present invention may use the concave/convex pattern formed over the substrate according to the concave/convex pattern forming method.

According to the information recording medium manufacturing method of the present invention, by manufacturing the information recording medium using the concave/convex pattern formed over the substrate according to the concave/convex pattern forming method, it is possible to form the concave/convex pattern with high accuracy over the whole area of the substrate by subjecting the substrate to an etching process using e.g., the formed concave/convex pattern as a mask pattern, or a concave/convex pattern matching the formed concave/convex pattern in the concave-convex positional relationship as a mask pattern.

It should be noted that the present disclosure relates to the subject matter included in Japanese Patent Application No. 2006-052242 filed Feb. 28, 2006, and Japanese Patent Application No. 2006-311360 filed Nov. 17, 2006, and it is apparent that all the disclosures therein are incorporated herein by reference.

### BRIEF DESCRIPTION OF THE DRAWINGS

These and other objects and features of the present invention will be explained in more detail below with reference to the attached drawings, wherein:

FIG. 1 is a schematic diagram of an imprinting apparatus;

FIG. 2 is a cross-sectional view of a magnetic disk;

FIG. 3 is a cross-sectional view of a stamper;

FIG. 4 is a cross-sectional view of an object to be processed, in a state in which a resin layer is formed on a recording layer;

FIG. 5 is a cross-sectional view of the object to be processed, in a state in which the stamper is pressed against the resin layer on the object to be processed;

FIG. 6 is a cross-sectional view of the object to be processed, in a state in which the stamper is removed from the resin layer in the state shown in FIG. 5;

FIG. 7 is a diagram useful in explaining ease of pushing the stamper into each of resin layers of Examples 1 to 4 and Comparative Examples 1 to 5, the shape stability of a concave/convex pattern transferred to each resin layer, and accuracy of transfer of the concave/convex pattern; and

FIG. 8 is a diagram useful in explaining the depth of concave portions (concave portions of a data track pattern area) of each resin layer of Examples 1 to 16 and Comparative Examples 1 and 5, after removal of the stamper, and the thickness of a residue on the bottoms of the concave portions.

### DESCRIPTION OF THE PREFERRED EMBODIMENTS

Now, the best mode of a concave/convex forming method and an information recording medium manufacturing method according to the present invention will be described with reference to the accompanying drawings.

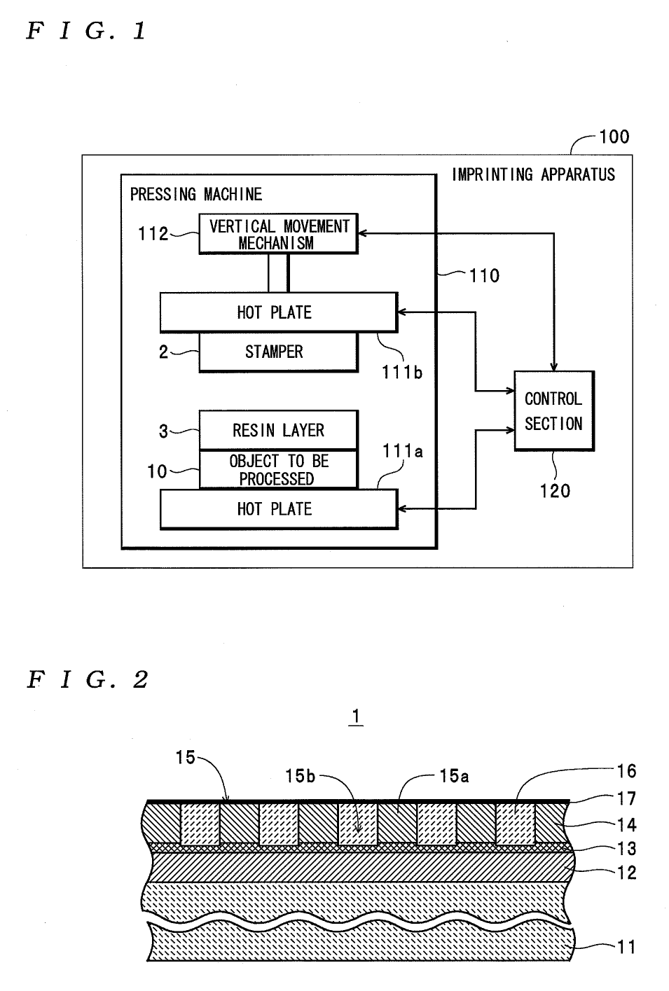

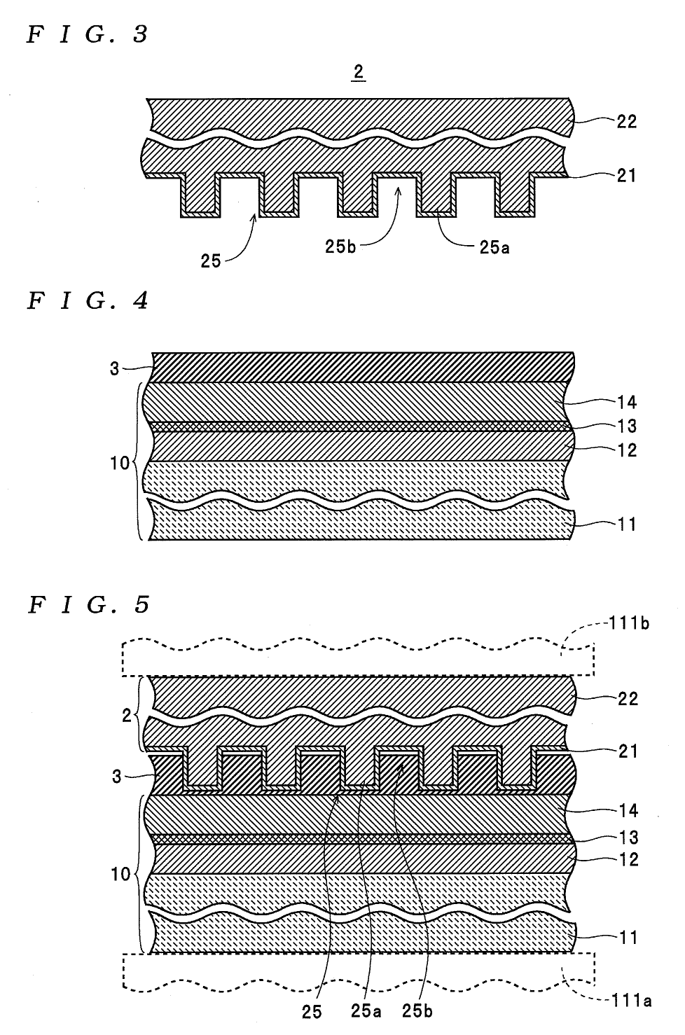

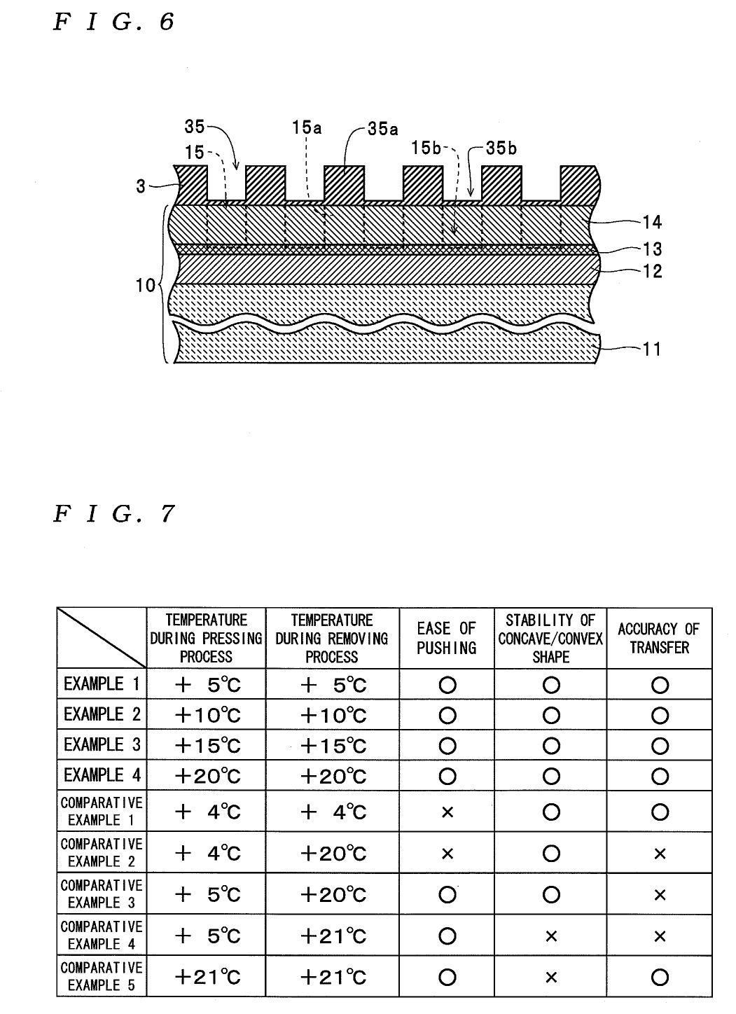

An imprinting apparatus 100 shown in FIG. 1 forms a concave/convex pattern 35 (see FIG. 6) by pressing a stamper 2 (see FIG. 3) against a resin layer 3 (see FIG. 5) on an object to be processed 10 (see FIG. 5) by a concave/convex pattern forming method of the present invention, in manufacturing a magnetic disk 1 shown in FIG. 2, and is comprised of a pressing machine 110, and a control section 120.

In this case, the magnetic disk 1 is a discrete track-type magnetic recording medium (patterned medium), which is configured to have plural concentric or helical data recording tracks formed thereon such that the magnetic disk 1 is capable of recording data by a perpendicular recording method. As shown in FIG. 2, the magnetic disk 1 has a soft magnetic layer 12, an intermediate layer 13, and a recording layer (magnetic recording layer) 14 sequentially formed on a disk-shaped base plate 11 in the mentioned order. The magnetic disk 1 corresponds to an information recording medium in the present invention, and has one surface thereof (upper surface thereof as viewed in FIG. 2) formed with a concave/convex pattern 15 which includes plural convex portions 15a (recording areas) each having at least a protruding end thereof made of a magnetic material (recording layer 14) and plural concave portions 15b (non-recording areas), and serves as a data track pattern or a servo pattern. Further, a non-magnetic material 16 is embedded in the concave portions 15b of the concave/convex pattern 15. Furthermore, a protective layer 17 is formed e.g., of DLC (Diamond Like Carbon) on the convex portions 15a and the non-magnetic material 16 embedded in the concave portions 15b, and a lubricant, not shown, is applied to the surface of the protective layer 17.

In this case, the term “recording area” is intended to mean an area which is configured to readably hold a recorded magnetic signal (that is, an area which is configured to have a capability of readably holding a magnetic signal). Further, throughout the present specification, the term “non-recording area” is intended to mean an area which is configured to have a lower capability of readably holding a magnetic signal than that of the recording area, or an area configured such that it does not substantially have such capability. More specifically, throughout the present specification, the term “non-recording area” is intended to mean an area which generates a smaller magnetic field than the recording area, in a state having a magnetic signal recorded thereon, or an area which generates substantially no magnetic field.

On the other hand, the stamper 2 is a master disk for forming a concave/convex pattern 35 (see FIG. 6) serving as a mask pattern on the object to be processed 10, when the magnetic disk 1 is manufactured, and is configured to be generally circular plate-shaped. As shown in FIG. 3, the stamper 2 has a shape of a thin plate formed by forming a nickel layer 22 on a nickel layer 21 by an electroforming process using the nickel layer 21 as an electrode. Further, the stamper 2 is formed with a concave/convex pattern 25 (an example of a “stamper-side concave/convex pattern” in the present invention) having plural convex portions 25a formed corresponding to the respective concave portions 15b of the concave/convex pattern 15 on the magnetic disk 1, and plural concave portions 25b formed corresponding to the respective convex portions 15a of the concave/convex pattern 15. Further, the object to be processed 10 is an example of the substrate in the present invention, and as shown in FIG. 4, has the soft magnetic layer 12, the intermediate layer 13, and the recording layer 14 sequentially formed on the disk-shaped base plate 11 in the mentioned order. In this case, as described hereinafter, the resin layer 3 is formed on the recording layer 14 of the object to be processed 10 according to a resin layer forming process in the present invention.

Referring to FIG. 1, the pressing machine 110 includes hot plates 111a and 111b (hereinafter also referred to as the “hot plates 111” when they are not distinguished from each other), and a vertical movement mechanism 112. The hot plates 111 heat the object to be processed 10 (resin layer 3) and the stamper 2 under the control of the control section 120 such that they have a predetermined temperature. Further, the hot plate 111a is configured to be capable of holding the object to be processed 10 in a state in which the surface thereof on which the resin layer 3 is formed faces upward, while the hot plate 111b is configured to be capable of holding the stamper 2 in a state in which the surface thereof on which the concave/convex pattern 25 is formed faces downward. The vertical movement mechanism 112 moves (lowers) the hot plate 111b toward the object to be processed 10 held by the hot plate 111a under the control of the control section 120 to thereby press the stamper 2 held by the hot plate 111b against the resin layer 3 on the object to be processed 10. Further, the vertical movement mechanism 112 causes the hot plate 111b to move (be lifted) away from the hot plate 111a, whereby the stamper 2 is removed from the resin layer 3. The control section 120 causes the hot plates 111 to heat the object to be processed 10 (resin layer 3) and the stamper 2 (controls the temperatures thereof), and causes the vertical movement mechanism 112 to press the stamper 2 against the object to be processed 10 (pressing process in the present invention), and remove the stamper 2 pressed against the object to be processed 10 from the object to be processed 10 (removing process in the present invention).

In manufacturing the above-described magnetic disk 1, first, the concave/convex pattern 35 as a mask pattern is formed on the object to be processed 10 according to the concave/convex pattern forming method of the present invention. In doing this, first, for example, a resin material which has a glass transition temperature of 34° C. (an example of a resin material which has a glass transition temperature higher than 25° C., which is an example of room temperature, and at the same time not higher than 40° C.), is applied onto the recording layer 14 of the object to be processed 10 by spin coating. In this case, an acrylic resin using PGMEA (propylene glycol monomethyl ether acetate) as a solvent can be employed, by way of example, as a resin material used for forming the resin layer 3. More specifically, it is possible to employ an acrylic resin a main component of which is a copolymer of acrylic acid ester, methacrylic acid ester, and styrene. Then, a baking process is carried out on a layer of the applied resin material e.g., at 90° C. for 90 seconds, whereby as shown in FIG. 4, the resin layer 3 having a thickness of approximately 75 nm is formed on the object to be processed 10. This completes the resin layer forming process in the present invention.

It should be noted that in the present specification, the glass transition temperature can be identified by a method of actually measuring the same according to a measurement standard, such as “JIS K7121-1987” (standard on the method for measuring the transition temperature of plastics). More specifically, the glass transition temperature in the present specification can be identified by measuring an intermediate-point glass transition temperature (Tmg) according to the differential scanning calorimetry (DSC) conforming to the above JIS standard. In the present specification, as the glass transition temperature of each resin material, the above-described intermediate-point glass transition temperature (Tmg) is described. In this case, as to the glass transition temperature of the above-described resin material to be applied to the recording layer 14 of the object to be processed 10 by spin coating, the intermediate-point glass transition temperature (Tmg) and a glass transition temperature calculated by a FOX formula (Phys. Rev., Vol. 86, 652 (1952)) were the same (34° C.). It should be noted that values shown in “Polymer handbook 4th Edition, John Wiley & Sons, Inc. (1999)” were used as the glass transition temperatures of the respective resin materials (resin materials, such as acrylic acid ester, methacrylic acid ester, and styrene) applied to the FOX formula.

Next, an imprinting process by the imprinting apparatus 100 is started. More specifically, first, as shown in FIG. 1, the object to be processed 10 is set in the pressing machine 110 (hot plate 111a) with the surface formed with the resin layer 3 facing upward, and the stamper 2 is set in the pressing machine 110 (hot plate 111b) with the surface formed with the concave/convex pattern 25 facing downward. Then, the control section 120 controls the hot plates 111, whereby both the object to be processed 10 (resin layer 3) and the stamper 2 are heated (temperature control in the present invention) such that the temperatures thereof become 45° C. (an example of a temperature higher than the glass transition temperature of a resin material forming the resin layer 3 by not less than 5° C.). In this case, in the concave/convex pattern forming method, the heat treatment (temperature control) is continuously carried out by the hot plates 111 during a time period from the start of pressing of the stamper 2 against the resin layer 3 to the completion of removal thereof, described hereinafter, such that the amounts of changes in the temperatures of both the object to be processed 10 (resin layer 3) and the stamper 2 are within a range e.g., of ±0.2° C. After that, the control section 120 causes the vertical movement mechanism 112 to lower the hot plate 111b toward the object to be processed 10 (resin layer 3) on the hot plate 111a, to thereby press the concave/convex pattern 25 of the stamper 2 against the surface of the resin layer 3 on the object to be processed 10 (the start of the pressing process in the present invention).

In this case, in the concave/convex pattern forming method, the concave/convex pattern 25 of the stamper 2 is pressed against the resin layer 3 in the state in which both the object to be processed 10 (resin layer 3) and the stamper 2 are heated to a temperature (45° C. in the illustrated example) higher than the glass transition temperature (34° C. in the illustrated example) of the resin material forming the resin layer 3 by not less than 5° C. Therefore, each convex portion 25a of the concave/convex pattern 25 on the stamper 2 is smoothly (easily) pushed into the resin layer 3. As a result, as shown in FIG. 5, the convex portion 25a of the stamper 2 is pushed deep enough into the resin layer 3. Subsequently, after a state in which a pressing force e.g., of 8.7 MPa is applied to the stamper 2 is maintained for five minutes, by way of example, the control section 120 causes the vertical movement mechanism 112 to move the hot plate 111b upward, to thereby remove the stamper 2 from the resin layer 3 (the removing process in the present invention). Then, after completion of the removing process, the object to be processed 10 (resin layer 3) is left standing in a state in which the heat treatment thereon is stopped, whereby the object to be processed 10 is cooled until the temperature thereof becomes equal to room temperature. Thus, the shape of the concave/convex pattern 25 on the stamper 2 is transferred to the resin layer 3, whereby the concave/convex pattern 35 is formed on the object to be processed 10, as shown in FIG. 6.

In this case, the concave/convex pattern 35 formed on the object to be processed 10 has concave portions 35b formed corresponding to the respective convex portions 25a of the concave/convex pattern 25 on the stamper 2, and convex portions 35a are formed corresponding to the respective concave portions 25b of the concave/convex pattern 25. Further, in the concave/convex pattern forming method, as described hereinabove, the heat treatment (temperature control) is continuously carried out during the time period from the start of pressing of the stamper 2 against the resin layer 3 to the completion of removal thereof, such that the amounts of changes in the temperatures of both the object to be processed 10 (resin layer 3) and the stamper 2 are within a range e.g., of ±0.2° C. Therefore, the temperature of the resin layer 3 at the completion of removal of the stamper 2 from the resin layer 3 is approximately equal to the temperature of the resin layer 3 at the start of pressing of the stamper 2 against the resin layer 3, i.e., the temperature higher than the glass transition temperature of the resin material forming the resin layer 3 by not less than 5° C., and is not higher than a temperature (45° C.±0.2° C. in the illustrated example) 20° C. higher than the glass transition temperature of the resin material. For this reason, it is possible to prevent the concave/convex pattern 35 formed on the resin layer 3 from being drastically deformed after completion of removal of the stamper 2 from the resin layer 3 (from being incapable of maintaining the shape of the concave/convex pattern 35). This completes the process for forming the concave/convex pattern 35 (mask pattern) by the concave/convex pattern forming method of the present invention.

Although the resin layer 3 can also be formed by using a resin material which has a glass transition temperature not lower than 40° C. in the above-described resin layer forming process, when this method is employed, a large amount of energy is consumed when the resin layer 3 whose temperature is approximately equal to room temperature (e.g., 25° C.) before the start of the pressing process is heated to a temperature higher than the glass transition temperature of the resin material by not less than 5° C., and at the same time it takes a long time to heat the resin layer 3 up to a desired temperature. In addition, since the temperature of the resin layer 3 is controlled such that the temperature of the resin layer 3 during the pressing process becomes equal (or approximately equal) to the temperature of the resin layer 3 in the removing process (so as to keep high temperatures of the object to be processed 10, the resin layer 3, and the stamper 2 until completion of removal of the stamper from the resin layer), a large amount of energy is consumed. Therefore, it is preferable to shorten the time period taken to raise the temperatures of the resin layer 3 and the like to a desired temperature while avoiding consumption of a large amount of energy, by forming the resin layer 3 using a resin material which has a glass transition temperature not higher than 40° C.

Then, a residue (resin material produced between a protruding end face of each convex portion 25a and the object to be processed 10 during pressing of the stamper 2 against the resin layer 3) remaining on the bottom surface of each concave portion 35b of the concave/convex pattern 35 formed on the resin layer 3 on the object to be processed 10 is removed e.g., by an oxygen plasma process. Subsequently, etching process is performed on (the recording layer 14 of) the object to be processed 10, using the concave/convex pattern 35 (the convex portions 35a thereof) as a mask pattern, whereby the concave/convex pattern 15 is formed on the intermediate layer 13. In this case, in the above-described concave/convex pattern forming method, the resin layer 3 is formed by coating the object to be processed 10 with a resin material which has a glass transition temperature higher than room temperature (25° C. in the illustrated example). Therefore, the concave/convex shape of the concave/convex pattern 35 are prevented from being largely deformed even if the temperature of the resin layer 3 is held at room temperature after removal of the stamper 2 from the resin layer 3 having the concave/convex pattern 35 formed thereon (before the start of the etching process on the object to be processed 10). As a result, as indicated by broken lines in FIG. 6, the convex portions 15a (recording areas) are formed corresponding to the respective convex portions 35a of the concave/convex pattern 35 in the state of its concave/convex shape being maintained, and the concave portions 15b (non-recording areas) are formed corresponding to the respective concave portions 35b of the concave/convex pattern 35, whereby the concave/convex pattern 15 is formed on the intermediate layer 13.

Subsequently, after a layer, not shown, of the non-magnetic material 16 is formed in a manner covering the concave/convex pattern 15 formed on the object to be processed 10, the surface of the layer of the non-magnetic material 16 is smoothed e.g., by an ion beam etching process. In doing this, the etching process is performed e.g., until the convex portions 15a of the concave/convex pattern 15 are exposed from the layer of the non-magnetic material. Then, the protective layer 17 is formed e.g., by DLC on the convex portions 15a and the non-magnetic material 16 embedded in the concave portions 15b of the smoothed object to be processed 10. After that, the lubricant is applied to the surface of the protective layer 17, whereby the magnetic disk 1 is completed, as shown in FIG. 2, to complete the process based on the information recording medium manufacturing method according to the present invention.

Next, the relationship between ease of pushing the convex portions of the stamper into the resin layer on the substrate, the shape stability of the concave/convex pattern after removal of the stamper (difficulty of deformation of the concave/convex pattern) and the accuracy of transfer of the pattern (whether or not the transferred pattern is displaced), and the temperature of the resin layer during the above-described processes, will be described with reference to drawings.

First, resin layers of Examples 1 to 4 and Comparative Examples 1 to 5 shown in FIG. 7 were formed on support substrates, not shown, by using a resin material (e.g., an acrylic resin which has a glass transition temperature of 34° C.) which has a glass transition temperature higher than room temperature (e.g., 25° C.). In this case, an acrylic resin (a main component of which is a copolymer of acrylic acid ester, methacrylic acid ester, and styrene) using PGMEA (propylene glycol monomethyl ether acetate) as a solvent was employed as the resin material, by way of example. Further, as for the glass transition temperature (34° C.) of this resin material, the intermediate-point glass transition temperature (Tmg) measured according to the above-described JIS standard, and a glass transition temperature calculated by the FOX formula were the same. Further, a concave/convex pattern was formed on the support substrate (on the resin layer formed thereon) by pressing the concave/convex pattern 25 of the stamper 2 against the resin layer of each of Examples and Comparative Examples. It should be noted that each resin layer was formed according to the same procedure as employed in the above-described method of forming the resin layer 3 and the concave/convex pattern 35 except for the temperature of the resin layer during pressing of the stamper 2 thereagainst, and the temperature of the resin layer during removal of the stamper 2 therefrom. The concave/convex shapes of surfaces of the resin layers of Examples and Comparative Examples, having the concave/convex pattern formed thereon as described above, were observed at room temperature by an atomic force microscope (AFM) to thereby check ease of pushing the convex portions 25a of the stamper 2 into each resin layer, the stability of the concave/convex shape after removal of the stamper 2 from the resin layer, and the accuracy of transfer of the pattern (whether or not the transferred pattern is displaced). The results of the check are shown in FIG. 7.

It should be noted that in FIG. 7, when faulty transfer of the concave/convex pattern was caused due to an insufficient pushing amount of the convex portions 25a into the resin layer, the symbol “X” was entered in the corresponding box under the column of “EASE OF PUSHING”, whereas when the convex portions 25a could be pushed easily deep enough into the resin layer, the symbol “O” was entered in the corresponding box under the column of “EASE OF PUSHING”. Further, when the concave/convex pattern was largely deformed in a short time after the stamper 2 was removed from the resin layer (when it was difficult to maintain the concave/convex shape), the symbol “X” was entered in the corresponding box under the column of “STABILITY OF CONCAVE/CONVEX SHAPE”, whereas when the amount of deformation of the concave/convex pattern after removal of the stamper 2 from the resin layer was sufficiently small, or when almost no deformation thereof was caused after removal of the stamper, the symbol “O” was entered in the corresponding box under the column of “STABILITY OF CONCAVE/CONVEX SHAPE”. Furthermore, when the transferred concave/convex pattern had been displaced at a time point of removal of the stamper 2, the symbol “X” was entered in the corresponding box under the column of “ACCURACY OF TRANSFER”, whereas when the concave/convex pattern was transferred with high accuracy without being displaced, the symbol “O” was entered in the corresponding box under the column of “ACCURACY OF TRANSFER”.

### EXAMPLE 1

The pressing process was carried out in a state in which the support substrate, the resin layer, and the stamper 2 were heated to a temperature (39° C. in the illustrated example) 5° C. higher than the glass transition temperature of the resin material forming the resin layer, and then the removing process was performed to remove the stamper 2 from the resin layer while maintaining the temperature at which the pressing process had been carried out.

### EXAMPLE 2

The pressing process was carried out in a state in which the support substrate, the resin layer, and the stamper 2 were heated to a temperature (44° C. in the illustrated example) 10° C. higher than the glass transition temperature of the resin material forming the resin layer, and then the removing process was performed to remove the stamper 2 from the resin layer while maintaining the temperature at which the pressing process had been carried out.

### EXAMPLE 3

The pressing process was carried out in a state in which the support substrate, the resin layer, and the stamper 2 were heated to a temperature (49° C. in the illustrated example) 15° C. higher than the glass transition temperature of the resin material forming the resin layer, and then the removing process was performed to remove the stamper 2 from the resin layer while maintaining the temperature at which the pressing process had been carried out.

### EXAMPLE 4

The pressing process was carried out in a state in which the support substrate, the resin layer, and the stamper 2 were heated to a temperature (54° C. in the illustrated example) 20° C. higher than the glass transition temperature of the resin material forming the resin layer, and then the removing process was performed to remove the stamper 2 from the resin layer while maintaining the temperature at which the pressing process had been carried out.

### COMPARATIVE EXAMPLE 1

The pressing process was carried out in a state in which the support substrate, the resin layer, and the stamper 2 were heated to a temperature (38° C. in the illustrated example) 4° C. higher than the glass transition temperature of the resin material forming the resin layer, and then the removing process was performed to remove the stamper 2 from the resin layer while maintaining the temperature at which the pressing process had been carried out.

### COMPARATIVE EXAMPLE 2

The pressing process was carried out in the state in which the support substrate, the resin layer, and the stamper 2 were heated to a temperature (38° C. in the illustrated example) 4° C. higher than the glass transition temperature of the resin material forming the resin layer, and then the support substrate, the resin layer, and the stamper 2 were heated, prior to the removing process, to the temperature (54° C. in the illustrated example) 20° C. higher than the glass transition temperature of the resin material, in a state in which application of a pressing force to the stamper 2 was stopped, followed by removing the stamper 2 from the resin layer.

### COMPARATIVE EXAMPLE 3

The pressing process was carried out in the state in which the support substrate, the resin layer, and the stamper 2 were heated to a temperature (39° C. in the illustrated example) 5° C. higher than the glass transition temperature of the resin material forming the resin layer, and then the support substrate, the resin layer, and the stamper 2 were heated, prior to the removing process, to the temperature (54° C. in the illustrated example) 20° C. higher than the glass transition temperature of the resin material, in the state in which application of the pressing force to the stamper 2 was stopped, followed by removing the stamper 2 from the resin layer.

### COMPARATIVE EXAMPLE 4

The pressing process was carried out in the state in which the support substrate, the resin layer, and the stamper 2 were heated to a temperature (39° C. in the illustrated example) 5° C. higher than the glass transition temperature of the resin material forming the resin layer, and then the support substrate, the resin layer, and the stamper 2 were heated, prior to the removing process, to a temperature (55° C. in the illustrated example) 21° C. higher than the glass transition temperature of the resin material, in the state in which application of the pressing force to the stamper 2 was stopped, followed by removing the stamper 2 from the resin layer.

### COMPARATIVE EXAMPLE 5

The pressing process was carried out in the state in which the support substrate, the resin layer, and the stamper 2 were heated to a temperature (55° C. in the illustrated example) 21° C. higher than the glass transition temperature of the resin material forming the resin layer, and then the removing process was performed to remove the stamper 2 from the resin layer while maintaining the temperature at which the pressing process had been carried out.

As shown in FIG. 7, in Examples 1 to 4 and Comparative Examples 3 to 5, in which the temperature of the resin layer during the process for pressing the stamper 2 against the resin layer was higher than the glass transition temperature (34° C. in the illustrated example) of the resin material forming the resin layer by not less than 5° C., the convex portions 25a of the stamper 2 could be pushed smoothly (easily) deep enough into the resin layer, whereby it was possible to avoid occurrence of faulty transfer of the concave/convex pattern. In contrast, in Comparative Examples 1 and 2, in which the temperature of the resin layer during the pressing process was higher than the glass transition temperature of the resin material by less than 5° C., the convex portions 25a of the stamper 2 could not be pushed deep enough into the resin layer, which caused faulty transfer of the concave/convex pattern. As described above, by performing heat treatment (temperature control) such that the temperature of the resin layer during the pressing process becomes higher than the glass transition temperature of the resin material by not less than 5° C., it is possible to avoid occurrence of faulty transfer of the concave/convex pattern.

In this case, in Examples 3 and 4, in which the temperature of the resin layer during the pressing process was higher than the glass transition temperature of the resin material by not less than 15° C., even when a method of shortening a time period over which the stamper is pressed against the resin layer, or a method of reducing the pressing force of the stamper against the resin layer was employed, the convex portions 25a of the stamper 2 could be pushed deep enough into the resin layer. More specifically, although in Examples 1 and 2, a state in which the pressing force of 8.7 MPa was applied to the stamper 2 was maintained for five minutes during the pressing process, in Examples 3 and 4, by maintaining a state in which a pressing force of 4.9 MPa was applied to the stamper 2 only for one minute during the pressing process, it was possible to transfer the concave/convex pattern without causing faulty transfer thereof. As described above, by performing heat treatment (temperature control) such that the temperature of the resin layer during the pressing process becomes higher than the glass transition temperature of the resin material by not less than 15° C., it is possible to shorten the time period taken to press the stamper 2 against the resin layer and sufficiently avoid occurrence of faulty transfer of the concave/convex pattern even with a smaller pressing force.

Further, in Examples 1 to 4 and Comparative Examples 1 to 3, in which the temperature of the resin layer during the process for removing the stamper 2 was not higher than a predetermined temperature (54° C. in the illustrated example) 20° C. higher than the glass transition temperature (34° C. in the illustrated example) of the resin material forming the resin layer, the concave/convex pattern was not largely deformed after removal of the stamper 2, and the concave/convex shape thereof was maintained with sufficiently high accuracy even at a time point after the lapse of a certain time period from the time point of removal of the stamper 2. In contrast, in Comparative Examples 4 and 5, in which the temperature of the resin layer during the removing process was higher than the predetermined temperature (54° C. in the illustrated example) 20° C. higher than the glass transition temperature of the resin material, the concave/convex pattern was largely deformed in a relatively short time period after removal of the stamper 2, and the concave/convex shape thereof could not be maintained. As described above, by performing heat treatment (temperature control) such that the temperature of the resin layer during the removing process becomes not higher than the predetermined temperature (54° C. in the illustrated example) 20° C. higher than the glass transition temperature of the resin material, it is possible to avoid large deformation of the concave/convex pattern after removal of the stamper 2 to maintain the concave/convex shape of the concave/convex pattern with high accuracy.

Furthermore, in Examples 1 to 4 and Comparative Examples 1 and 5, in which the temperature of the resin layer during the pressing process and the temperature of the resin layer during the removing process were equal (or approximately equal) to each other, the support substrate, the resin layer, and the stamper 2 were prevented from being thermally deformed to thereby prevent occurrence of displacement of the concave/convex pattern transferred to the resin layer. In contrast, in Comparative Examples 2 to 4, in which the temperature of the resin layer during the pressing process and the temperature of the resin layer during the removing process were largely different from each other, the support substrate, the resin layer, and the stamper 2 were thermally deformed (contracted), causing different amounts of deformations. As a consequence, there occurred displacement of the concave/convex pattern transferred to the resin layer. As described above, by performing temperature control such that the temperature of the resin layer during the pressing process and the temperature of the resin layer during the removing process become equal (or approximately equal) to each other, it is possible to avoid occurrence of displacement of the transferred concave/convex pattern.

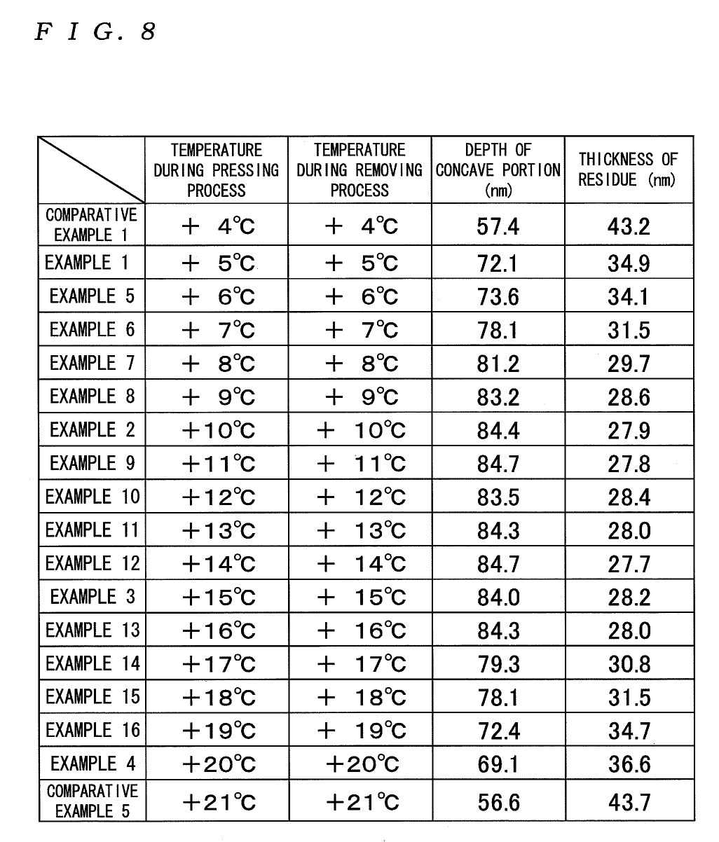

Next, the relationship between the depth of each concave portion 35b formed in the resin layer and the thickness of a residue remaining on the bottom surface of the concave portion 35b, and the temperatures of the resin layer during the pressing and removing processes will be described with reference to drawings. It should be noted that each of the resin layers of Examples 5 to 16 appearing in FIG. 8 was formed according to the same procedure as employed in the above-described method of forming the resin layers and the concave/convex patterns 35 of Examples 1 to 4, except for the temperature of the resin layer during pressing of the stamper 2 thereagainst, and the temperature of the resin layer during removal of the stamper 2 therefrom. Further, the depth of each concave portion 35b was measured using the atomic force microscope (AFM) in a data track pattern area at room temperature. Furthermore, the thickness of the residue was measured by observing the cross section of each concave/convex pattern in the data track pattern area using a scanning electron microscope (SEM) at room temperature. Further, a ratio between the width of the convex portion 35a and the width of the concave portion 35b in the data track pattern area is 10:8.

As shown in FIG. 8, in the resin layers of Examples 1 to 16, which were formed under conditions that the temperature of the resin layer during the process for pressing the stamper 2 became higher than the glass transition temperature (34° C. in the illustrated example) of the resin material by not less than 5° C., and that the temperature of the resin layer during the process for removing the stamper 2 became not higher than the predetermined temperature (54° C. in the illustrated example) 20° C. higher than the glass transition temperature of the resin material, the depth of the concave portion 35b formed in the resin layer by pressing the stamper 2 thereagainst is within a range of 69.1 nm to 84.7 nm, which means that the concave portion 35b is deep enough, and the maximum thickness of each residue on the bottom surface of the concave portion 35b is 36.6 nm, which means that the residue is thin enough. In contrast, in the resin layer of Comparative Example 1, which was formed under the condition that the temperature of the resin layer during the pressing process became 4° C. higher than the glass transition temperature of the resin material, the depth of the concave portion 35b formed by pressing the stamper 2 against the resin layer is 57.4 nm, which means that the concave portion 35b is shallow, and the thickness of a residue on the bottom surface of the concave portion 35b is 43.2 nm, which means that the residue is very thick. Further, in the resin layer of Comparative Example 5, which was formed under the condition that the temperature of the resin layer during the removing process became 21° C. higher than the glass transition temperature (34° C. in the illustrated example) of the resin material, the depth of the concave portion 35b formed by pressing the stamper 2 against the resin layer is 56.6 nm, which means that the concave portion 35b is shallow, and the thickness of a residue on the bottom surface of the concave portion 35b is 43.7 nm, which means that the residue is very thick.

In this case, for example, between the resin layers of Examples 1 and 5, between which the difference in the temperature of the resin layer during the pressing process is 1° C., the difference in the depth of the concave portion 35b is 1.5 nm, which is very small, whereas between the resin layers of Example 1 and Comparative Example 1, between which the difference in the temperature of the resin layer during the pressing process is the same 1° C. as in Examples 1 and 5, the difference in the depth of the concave portion 35b is 14.7 nm, which is very large. Further, between the resin layers of Examples 1 and 5, the difference in the thickness of the residue is 0.8 nm, which is very small, whereas between the resin layers of Example 1 and Comparative Example 1, the difference in the thickness of the residue is 8.3 nm, which is very large. Therefore, it can be understood that there occurs a large difference in ease of pushing the concave/convex pattern into the resin layer between when the heat treatment (temperature control) is carried out such that the temperature of the resin layer during the pressing process becomes higher than the glass transition temperature of the resin material by not less than 5° C., and when the heat treatment (temperature control) is carried out such that the temperature of the resin layer during the pressing process becomes higher than the glass transition temperature of the resin material by less than 5° C.

Further, for example, between the resin layers of Examples 4 and 16, between which the difference in the temperature of the resin layer during the removing process is 1° C., the difference in the depth of the concave portion 35b is 3.3 nm, which is very small, whereas between the resin layers of Example 4 and Comparative Example 5, between which the difference in the temperature of the resin layer during the removing process is the same 1° C. as in Examples 4 and 16, the difference in the depth of the concave portion 35b is 12.5 nm, which is very large. Further, between the resin layers of Examples 4 and 16, the difference in the thickness of the residue is 1.9 nm, which is very small, whereas between the resin layers of Example 4 and Comparative Example 5, the difference in the thickness of the residue is 7.1 nm, which is very large. Therefore, it can be understood that there occurs a large difference in the stability (liability of deformation) of the concave/convex shape of the concave/convex pattern between when the heat treatment (temperature control) is carried out such that the temperature of the resin layer during the removing process becomes not higher than the predetermined temperature (54° C. in the illustrated example) 20° C. higher than the glass transition temperature of the resin material, and when the heat treatment (temperature control) is carried out such that the temperature of the resin layer during the removing process becomes higher than the predetermined temperature (54° C. in the illustrated example) 20° C. higher than the glass transition temperature of the resin material.

It should be noted that as is apparent from FIG. 8, between when the temperature of the resin layer during the pressing process is higher than the glass transition temperature of the resin material by not less than 5° C., and when the temperature of the resin layer during the pressing process is higher than the glass transition temperature of the resin material by less than 5° C., the relationship between the difference in the temperature of the resin layer during the pressing process and the difference in the depth of the concave portion (or the thickness of the residue) is largely changed. Therefore, by measuring the depth of a concave portion 35b (or the thickness of a residue on the bottom surface of the concave portion 35b) of a resin layer which is made of a resin material having an unknown glass transition temperature while varying the temperature of the resin layer during the pressing process in steps of 1° C., it is possible to identify two temperatures (38° C. and 39° C. in the illustrated example), between which the difference in the depth (thickness) with respect to the difference in the temperature is largely different (i.e., largely changed), whereby a temperature (34° C. in the illustrated example) 5° C. lower than a temperature (39° C. in the illustrated example) the higher of the two identified temperatures can be determined as the glass transition temperature of the resin material forming the resin layer.

As described hereinabove, according to the concave/convex pattern forming method by the imprinting apparatus 100, the resin layer 3 is formed using a resin material having a glass transition temperature higher than room temperature, the temperature control is carried out during the pressing process such that the temperatures of the object to be processed 10, the resin layer 3, and the stamper 2 become higher than the glass transition temperature of the resin material by not less than 5° C., and the temperature control is carried out during the removing process such that the temperatures of the object to be processed 10, the resin layer 3, and the stamper 2 become not higher than a temperature 20° C. higher than the glass transition temperature of the resin material, and is equal or approximately equal to the temperatures of the object to be processed 10, the resin layer 3, and the stamper 2 during the pressing process. As a consequence, since the temperature of the resin layer 3 during the process for pressing the stamper 2 is higher than the glass transition temperature of the resin material by not less than 5° C., the convex portions 25a of the concave/convex pattern 25 can be pushed smoothly deep enough into the resin layer 3. Further, since the temperature of the resin layer 3 during the process for removing the stamper 2 is not higher than the temperature 20° C. higher than the glass transition temperature of the resin material, it is possible to avoid large deformation of the concave/convex pattern 35 transferred to the resin layer 3, after removal of the stamper 2, to thereby maintain the concave/convex shape of the concave/convex pattern with high accuracy. Furthermore, since the temperature of the resin layer 3 during the pressing process is equal or approximately equal to the temperature thereof during the removing process, it is possible to avoid occurrence of thermal deformation of the object to be processed 10 (resin layer 3) and the stamper 2, to thereby prevent occurrence of displacement of the concave/convex pattern 35 transferred to the resin layer 3.

Further, according to the concave/convex pattern forming method by the imprinting apparatus 100, by forming the resin layer 3 using a resin material having a glass transition temperature not higher than 40° C., as the resin material in the present invention, it is possible to sufficiently reduce energy required for heating the resin layer 3 prior to the start of the pressing process, and energy required for maintaining the temperature of the resin layer 3 from the start of the pressing process until the completion of the removing process, and sufficiently shorten time taken to heat the resin layer 3 to thereby sufficiently increase throughput in forming the concave/convex pattern.

Further, according to the above-described information recording medium manufacturing method, the magnetic disk 1 (information recording medium) is manufactured by using the concave/convex pattern 35 formed on the object to be processed 10 (substrate) according to the concave/convex pattern forming method. Therefore, e.g., by performing an etching process on the object to be processed 10, using the concave/convex pattern 35 as a mask pattern or a concave/convex pattern matching the concave/convex pattern 35 in the concave-convex positional relationship as a mask pattern, it is possible to form the concave/convex pattern 15 on the whole area of the object to be processed 10 with high accuracy.

It should be noted that the present invention is by no means limited to the above-described configurations and methods. For example, although in the above-described concave/convex pattern forming method, heat control is carried out by performing heat treatment on the object to be processed 10, the resin layer 3, and the stamper 2 such that the resin layer 3 has a desired temperature during the pressing process of the stamper 2 and the removing process thereof, it is possible to employ a method of carrying out temperature control such that the resin layer 3 has the desired temperature, by cooling the object to be processed 10 (the resin layer 3) and the stamper 2 under conditions that the temperature of the resin layer 3 during the pressing and removing processes becomes higher than the desired temperature (e.g., when the temperature of a work place where the imprinting process is performed is high, or the temperature of the resin layer 3 is increasing by the baking process). Further, the information recording media manufactured by the information recording medium manufacturing method according to the present invention are not limited to magnetic recording media, such as the magnetic disk 1, based on the perpendicular recording method, but the present invention can also be applied to magnetic recording media based on a longitudinal recording method.

Furthermore, although in the above-described the magnetic disk 1, the whole of each convex portion 15a of the concave/convex pattern 15, from a protruding end (front surface side of the magnetic disk 1) to a root portion thereof, is formed by the recording layer 14 (magnetic material), the construction of the information recording media manufactured by the information recording medium manufacturing method according to the present invention is not limited to this. More specifically, for example, when the recording layer 14 is etched using the concave/convex pattern 35 (mask pattern) formed by the concave/convex pattern forming method according to the present invention, by reducing an etching amount of the recording layer 14 to a certain degree (the concave portions 15b formed are made shallower), it is possible to form a magnetic disk, not shown, on which not only the convex portions 15a (recording areas) but also the concave portions 15b (non-recording areas) including their bottoms are formed from the recording layer 14. Further, when the recording layer 14 is etched using the concave/convex pattern 35 (mask pattern) formed by the concave/convex pattern forming method according to the present invention, by increasing the etching amount of the recording layer 14 to a certain degree (the concave portions 15b formed are made deeper), it is possible to form a magnetic disk, not shown, having a concave/convex pattern 15 formed thereon, which has convex portions 15a (recording areas) each having only a protruding end thereof (front surface side of the magnetic recording medium) formed from the recording layer 14, and a root portion thereof formed of a non-magnetic material or a soft magnetic material.

Furthermore, by forming a concave/convex pattern (concave/convex pattern similar to the concave/convex pattern 15 in the concave-convex positional relationship: not shown) on the disk-shaped base plate 11 by etching the disk-shaped base plate 11 using the concave/convex pattern (mask pattern) formed by the concave/convex pattern forming method according to the present invention, and forming a thin recording layer 14 in a manner covering the formed concave/convex pattern, it is possible to form a magnetic disk having a concave/convex pattern 15 formed thereon, which has plural convex portions 15a (recording areas) surfaces of which are formed of a magnetic material, and plural concave portions 15b (non-recording areas) bottom surfaces of which are formed of a magnetic material. Further, it is possible to form a magnetic disk, not shown, by forming a concave/convex pattern (mask pattern) on a layer formed of one of various materials having a low capability of readably holding a magnetic signal, or various materials (e.g., a non-magnetic material) which do not substantially have the capability, by the concave/convex pattern forming method according to the present invention, forming a concave/convex pattern (concave/convex pattern having an inverted concave-convex positional relationship with respect to the concave/convex pattern 15: concave/convex pattern having convex portions made e.g., of a non-magnetic material) on a layer e.g., made of a non-magnetic material by using the concave/convex pattern, and filling the concave portions of the concave/convex pattern with various materials (e.g., a magnetic material) having a high capability of readably holding a magnetic signal. In this case, in the magnetic recording medium manufactured by the manufacturing method, areas where convex portions of the concave/convex pattern formed on the layer e.g., of the non-magnetic material are formed correspond to the non-recording areas, while areas (areas having the magnetic material filled therewith) where concave portions of the concave/convex pattern are formed correspond to the recording areas.

Moreover, although in the above-described the magnetic disk 1, the plural concentric or helical data recording tracks are formed, this is not limitative, but the configuration of the information recording media manufactured by the information recording medium manufacturing method according to the present invention includes a patterned medium in which recording areas forming the data recording tracks are separated from each other in a manner sandwiching the associated non-recording areas in the circumferential direction of the magnetic recording medium. Further, the information recording media manufactured by the information recording medium manufacturing method according to the present invention are not limited to magnetic recording media, such as the magnetic disk, but they include various kinds of information recording media, such as optical discs and magneto-optical disks. Furthermore, although the description has been given of the example in which the resin layer is formed over one surface of the substrate in the present invention and the concave/convex pattern is formed as a mask pattern by the imprinting process, this is not limitative, but when an information recording medium of a double-sided recording type is manufactured, the present invention can be applied, when resin layers are formed over the front surface and the back surface of a substrate and concave/convex patterns are formed on both the resin layers by pressing stampers thereagainst.

What is claimed is:

1. A concave/convex pattern forming method comprising: a resin layer forming process for forming a resin layer over a substrate; a pressing process for pressing a stamper having a stamper-side concave/convex pattern formed thereon against the resin layer; and a removing process for removing the stamper from the resin layer, thereby forming a concave/convex pattern over the substrate,
wherein: during the resin layer forming process, the resin layer is formed using a resin material having a glass transition temperature higher than room temperature; during the pressing process, temperature control is performed such that respective temperatures of the substrate, the resin layer, and the stamper become higher than the glass transition temperature of the resin material by not less than 5° C.; and during the removing process, temperature control is performed such that respective temperatures of the substrate, the resin layer, and the stamper become not higher than a temperature 20° C. higher than the glass transition temperature of the resin material, and are equal or approximately equal to the respective temperatures of the substrate, the resin layer, and the stamper during the pressing process.

2. A concave/convex pattern forming method according to claim 1, wherein a resin material having a glass transition temperature not higher than 40° C. is used as the resin material.

3. An information recording medium manufacturing method using the concave/convex pattern formed over the substrate by the method according to claim 1.

4. An information recording medium manufacturing method using the concave/convex pattern formed over the substrate by the method according to claim 2.
